(19) United States
(12) Patent Application Publication
(10) Pub. No.: US 2021/0264340 A1
(43) Pub. Date: Aug. 26, 2021

(54) System and Method for Automatic Infrastructure Cloud Cost Optimization and Comparison

(71) Applicant: Gurumoorthi Velampalayam Marappagounder, Irving, TX (US)

(72) Inventor: Gurumoorthi Velampalayam Marappagounder, Irving, TX (US)

(21) Appl. No.: 17/185,843

(22) Filed: Feb. 25, 2021

Related U.S. Application Data
(60) Provisional application No. 62/982,013, filed on Feb. 26, 2020.

(51) Int. Cl. G06Q 10/06

(52) U.S. Cl. CPC G06Q 10/06315

(57) ABSTRACT

An automated infrastructure cost optimization method includes executing a script configured to collect information about at least one component of an infrastructure and generating a log file describing the at least one component, receiving a custom file specifying application and static information at least one additional component in the infrastructure, automatically generating a discovery report describing the at least one components and at least one additional component, automatically collecting pricing information of the at least one components and at least one additional component, automatically comparing the collected pricing information, and automatically generating a pricing comparison report.

### RELATED APPLICATION

This patent application claims the benefit of U.S. Provisional Patent Application No. 62/982,013 filed on Feb. 26, 2020, incorporated herein by reference.

### FIELD

The present disclosure relates to computer systems and computer software and in particular to a system and method for inventory management, lifecycle management, cloud optimization and comparison, and computer data migration and disk mapping using an automatic computer system infrastructure analytic engine to automate the most time-consuming tasks of data capture, analyzing, planning, validation and project management.

### BACKGROUND

The workplace is changing and that is putting new demands on information technology (IT). There's a changing structure to the workforce too with remote, part-time and freelance employees as well as full-time office-based staff. Approximately 22 percent of Americans work from home and 50 percent are involved with remote or virtual team working, according to the U.S. Bureau of Labor Statistics. Remote working is increasing, but 38 percent of respondents feel they are not equipped with the right technology to work effectively away from the office, according to a study by Deloitte. In this distributed environment, effective collaboration is critical. Deloitte reports that 70 percent of business leaders believe workers will spend more time on collaboration platforms.

These trends make it essential for IT to adapt its services and support to the needs of new working practices and new workspaces by capitalizing on the cloud. The challenge for IT is to provide secure access to services, applications and data to the workforce, wherever they are located. Deployment of cloud computing and storage capabilities provides the solution for remote employees and virtual teams to access their essential tools anywhere at any time using their mobile devices and a high-speed Internet connection.

Cloud scalability will also be important because the availability of virtual resources will allow businesses to easily outsource services like call centers, technical support, marketing and product development. During peak operations, cloud-based resources can scale on demand to meet the increased workloads. However, datacenter, cloud migration is a time-consuming task that commonly lead to downtime, increased costs and delays to critical company projects and business processes. Migration consists of many small, repetitive tasks across complex infrastructures that must be completed quickly and accurately.

### BRIEF DESCRIPTION OF THE DRAWINGS

FIG. 1 is a simplified block diagram illustrating a comprehensive analytic engine to automate the most time-consuming tasks of data capture, analyzing, planning, validation and project management according to the teachings of the present disclosure;

FIG. 2 is a simplified flow chart of an exemplary method of a comprehensive analytic engine according to the teachings of the present disclosure;

FIG. 3 is a simplified block diagram of an automatic source discovery module and user interface according to the teachings of the present disclosure;

FIG. 4 is a simplified block diagram of an automatic lifecycle management module and user interface according to the teachings of the present disclosure;

FIG. 5 is a simplified block diagram of a discovery reporting module and user interface according to the teachings of the present disclosure;

FIG. 6 is a simplified flowchart of a lifecycle management module and user interface according to the teachings of the present disclosure;

FIG. 7 is a more detailed flowchart of the automated inventory management method according to the teachings of the present disclosure;

FIG. 8 is a simplified block diagram of an optimization report module and user interface according to the teachings of the present disclosure;

FIG. 9 is a simplified block diagram of an artificial intelligence data collection engine according to the teachings of the present disclosure;

FIG. 10 is a more detailed flowchart of an analytic engine for cost optimization method according to the teachings of the present disclosure;

FIG. 11 is a simplified block diagram illustrating an analytic engine for performing automatic migration disk mapping according to the teachings of the present disclosure;

FIG. 12 is another simplified block diagram illustrating an analytic engine for performing automatic migration disk mapping according to the teachings of the present disclosure;

FIG. 13 is yet another simplified block diagram illustrating an analytic engine for performing automatic migration disk mapping according to the teachings of the present disclosure;

FIG. 14 is a flowchart of an automatic migration disk mapping method according to the teachings of the present disclosure;

FIG. 15 is a block diagram of a reporting tool for automatic migration disk mapping according to the teachings of the present disclosure;

FIG. 16 is a simplified block diagram of a migration management user interface according to the teachings of the present disclosure;

FIGS. 17-20 are further flowcharts of the analytic engine data migration disk mapping process according to the teachings of the present disclosure;

FIG. 21 is a simplified block diagram of a favorite views process according to the teachings of the present disclosure;

FIGS. 22 and 23 are simplified block diagrams of a dynamic charts process according to the teachings of the present disclosure;

FIG. 24 is a simplified block diagram of an advance filter process according to the teachings of the present disclosure;

FIG. 25 is a simplified block diagram of a health check report process according to the teachings of the present disclosure;

FIGS. 26-29 are flowcharts illustrating the user experience and reporting tool process according to the teachings of the present disclosure; and

FIGS. 30-50 are exemplary screenshots of the user experience and reporting tool process according to the teachings of the present disclosure.

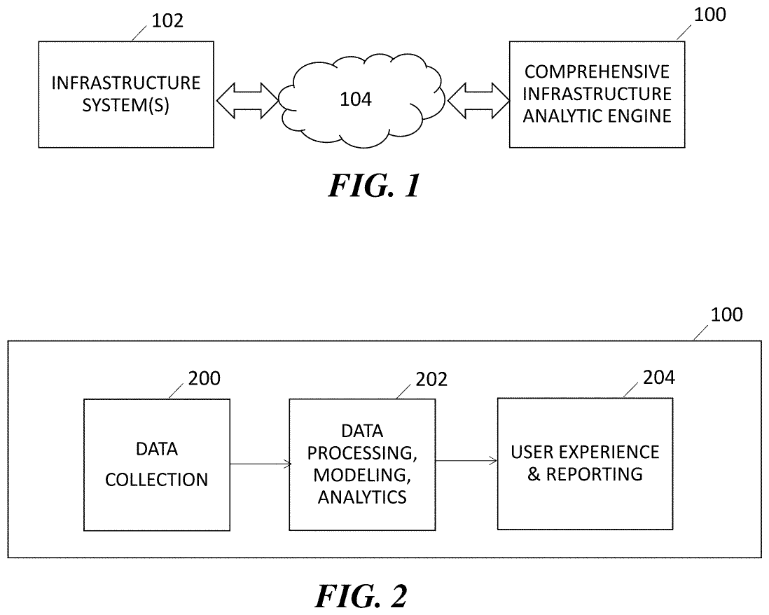

### DETAILED DESCRIPTION

Described herein is a comprehensive infrastructure analytic engine 100 that is operable to perform various analysis on a computer infrastructure system 102. The infrastructure system 102 may include a plurality of servers, switches, storages, firewalls, etc. For example, analytic engine 100 may be used to manage the infrastructure system 102 to automate and perform the most time-consuming tasks of system lifecycle management, inventory management, cost optimization, migration disk mapping, data migration, and reporting tools. The infrastructure system 102 and analytic engine 100 may be connected via one or more computer networks 104. The computer networks 104 may include any one or more of information distribution network(s), of any type(s) or topology(s), alone or in combination(s), such as internet(s), intranet(s), cloud(s), LAN(s), WAN(s), and may incorporate any one or more of cable, fiber, satellite, telephone, cellular, wireless, etc. As shown in FIG. 2, the analytic engine 100 includes a data collection module or process 200, a data processing/modeling/analytics module or process 202, and a user experience & reporting module or process 204.

Automated Lifecycle Management

Lifecycle management is an integrated and flexible approach to business management that draws on the principles of lifecycle thinking to help businesses understand their environmental impacts and where they occur within the lifecycle of their operations through the end-of-life of their infrastructure components. When a component is at the end of its lifecycle, it is at the end of its useful life (from the vendor's point of view), called EOL (end of life) or EOS (end of support). At this stage, a vendor stops the marketing, selling, or provision of parts, services or software updates for the product. A company may want to manage its infrastructure lifecycle for several reasons. The company may desire to reorganize or better manage the way its infrastructure is maintained. The company may want to maintain insight of the infrastructure devices. The company may want to retire or decommission older devices in order to reduce the impact of device failure. For a variety of reasons, infrastructure inventory management is a non-trivial matter.

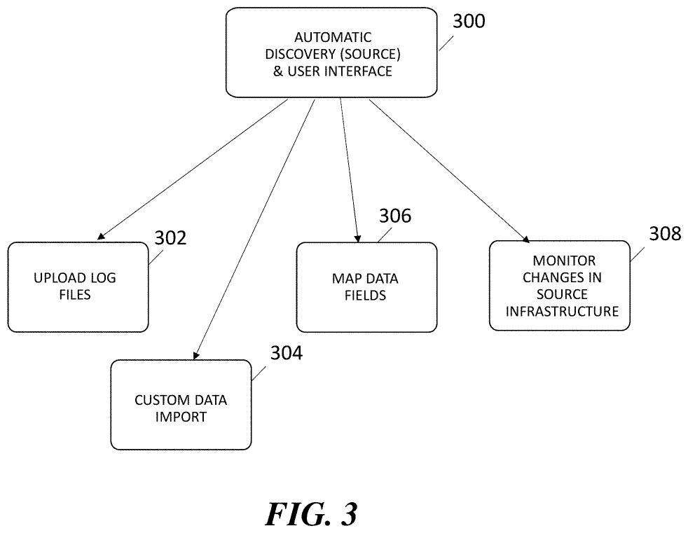

Referring to FIG. 3, the system infrastructure is determined by using an automated process 300 to automatically discover the infrastructure devices: servers, storage, and switches. Devices are identified by, for example, name, serial number, and IP address. Scripts are used to generate vendor-specific log files by discovering and identifying these devices in the infrastructure system, and these log files are then uploaded, as shown in block 302. Further, custom files (customer-specific static data or from other systems) that identify these devices can also be imported, as shown in block 304. These custom files can be in any format, such as comma separated values (CSV), Excel spreadsheet (XLS), etc. A user interface is provided to enable uploading log files and import custom files. The user interface also enables the data fields in these custom files to be identified or mapped to standard data fields, as shown in block 306. The system further includes log files that are generated by scripts used to automatically monitor changes in the source (servers, capacity, status, etc.), as shown in block 308.

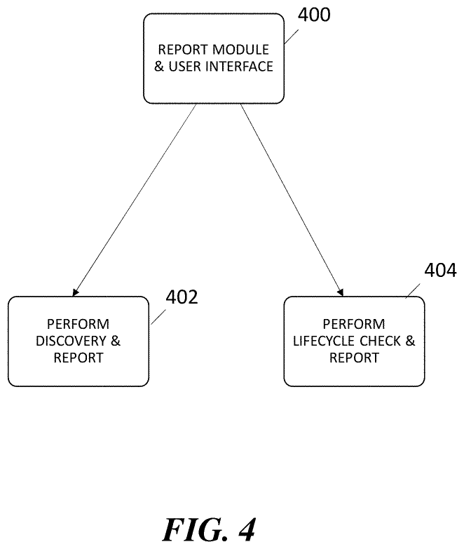

Referring to FIG. 4, the analytic engine 100 also includes a report module and user interface 400. As shown in FIG. 3, log files and custom data files are used to identify the infrastructure devices, and discovery reports providing summaries and details of the discovery procedure are available, as shown in block 402. The report module 400 is also configured to perform a lifecycle check of the infrastructure components and generate an End-of-Life report, as shown in block 404.

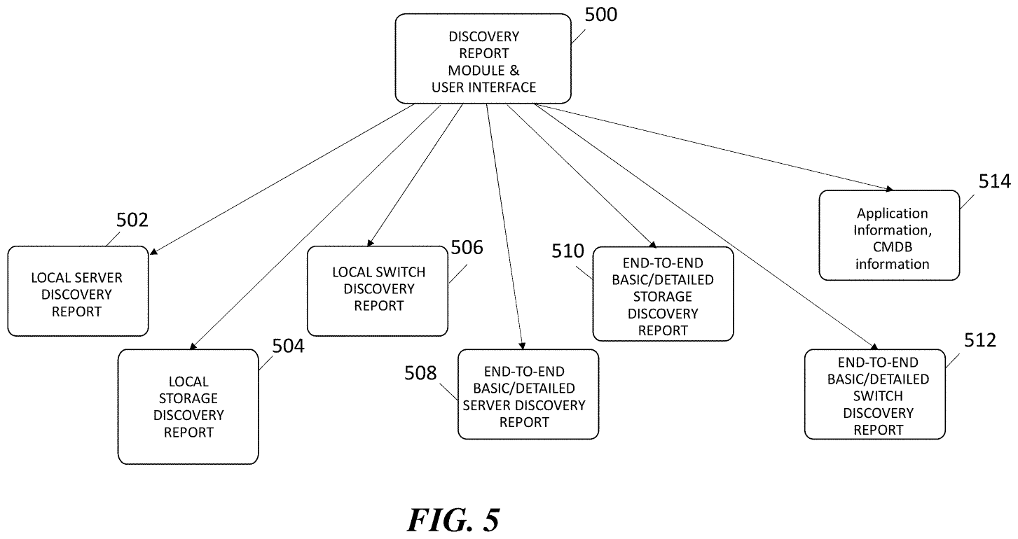

Referring to FIG. 5, the analytic engine 100 further includes a discovery report module and user interface 500 configured to generate several discovery reports, including a local server discovery report 502 that identifies and provides information on the local servers, local storage discovery report 504 that identifies and provides information on the local storage devices, local switch discovery report 506 that identifies and provides information on the local switches, end-to-end basic and detailed server discovery report 508 provides information of the server details along with the switch and storage to which it is connected, end-to-end basic and detailed storage discovery report 510 provides information of the storage details along with the servers and switches connected to it, and end-to-end basic and detailed switch discovery report 512 provides information of the switch details along with the servers and storage connected to it. In block 514, application information, system configuration management database information, and all other external sources are displayed against the hosts.

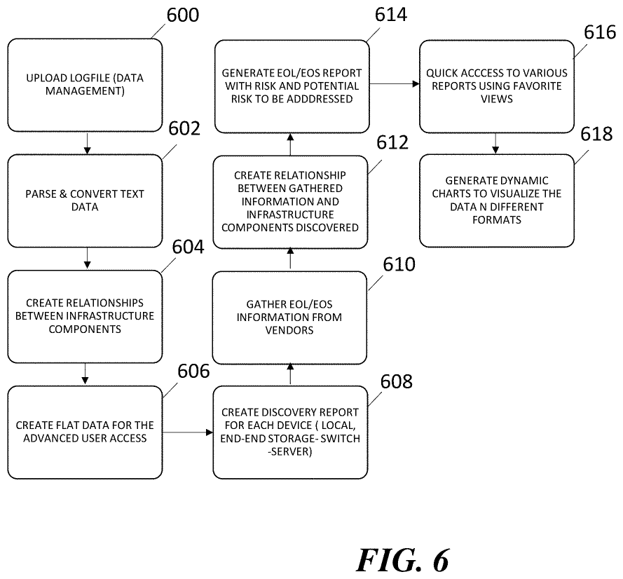

Referring to FIG. 6, a method to import system configuration data to inventory management is shown. In block 600, a log file is uploaded. The text in the log file is parsed and unstructured text is converted to structured text, as shown in block 602. The method then creates relationships between different infrastructure components like servers, switches and storage, etc. that are connected to each other, as shown in block 604. Flat data is then created for the advanced users, as shown in block 606. Unstructured data from commands converted to structured data with relationship which advanced user can use for deep analysis. The method then creates a discovery report for each infrastructure device, as shown in block 608. The method gathers the end-of-service (EOS) or end-of-life (EOL) information of the infrastructure components from all the vendors, as shown in block 610. Further, a relationship is created between all the infrastructure devices and the end-of-life information gather from the vendors, as shown in block 612. An end-of-life report for the environment is generated, as shown in block 614. The system and method include option for the users to create favorites views to ease the navigation inside the system, as shown in block 622. The system and method include option for the users to create and share dynamic charts for all the reports to visualize the data in different formats as shown in block 624.

Automated Inventory Management

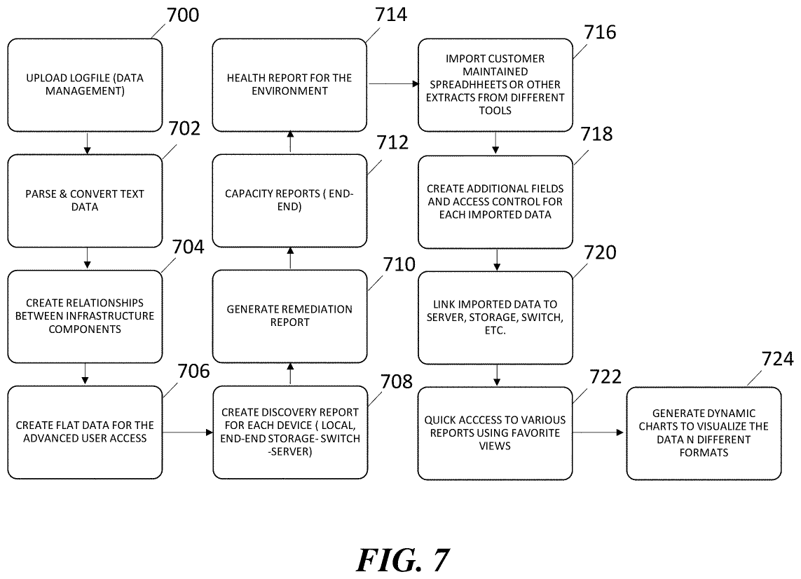

The analytic engine 100 may further perform the task of inventory management, which is the process of sourcing, storing, maintaining, and transforming data of infrastructures in any datacenter or organization. Referring to FIG. 7, a method to import system configuration data for inventory management is shown. In block 700, a log file is uploaded. The text in the log file is parsed and unstructured text is converted to structured text, as shown in block 702. The method then creates relationships between different infrastructure components like servers, switches and storage, etc. that are connected to each other, as shown in block 704. Flat data is then created for the advanced users, as shown in block 706. Unstructured data from commands converted to structured data with relationship which advanced user can use for deep analysis. The method then creates a discovery report for each infrastructure device, as shown in block 708. A remediation report is generated, as shown in block 710. The remediation report provides information on those hosts that have components that are lacking or requires upgrade to make the hosts compatible with the target environment. Further, a capacity report is generated, as shown in block 712. A health report for the environment is also generated, as shown in block 714. This report validates captured data against the industry best practices and specific best practices with the option to show in different color codes based on the criticality. The company's system configuration data that may have been generated by other tools are also uploaded or imported, as shown in block 716. The customer infrastructure data may be in a number of predetermined log file formats, such as CSV (comma-separated values) and XLS (Microsoft Excel) formats. The method then generates additional fields and specifies access control rules for the imported data, as shown in block 718. The imported data is then linked to the servers, switches, etc. in the infrastructure system, as shown in block 720. The system and method include option for the users to create favorites views to ease the navigation inside the system, as shown in block 722. The system and method include option for the users to create and share dynamic charts for all the reports to visualize the data in different formats as shown in block 724.

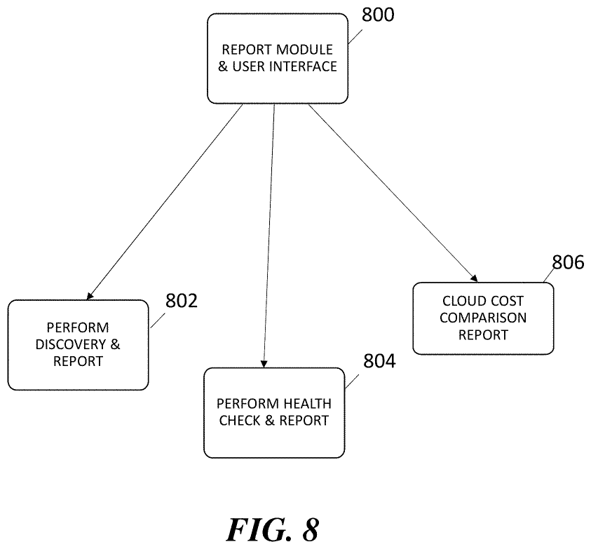

Referring to FIG. 8, the analytic engine 100 includes a report module and user interface 800. As described above, the automatic discovery process/module is used to determine and discover the system infrastructure devices. Discovery reports are generated that provide summaries and details of the discovery procedure, as shown in block 802. The report module 800 is also configured to perform a health check of the infrastructure and generate a health-check (configurable specific to customer) report, as shown in block 804. The report module 800 is also configured to compare the configuration of the server with multiple cloud service vendors and provide operating costing information, as shown in block 806.

Automated Infrastructure Cloud Optimization

Cost optimization is the process of comparing the current infrastructure cost vs the cost for utilizing cloud vendors and reduce the infrastructure cost. This involves the automated process of collecting data from log files and collecting cloud vendors data from, for example, AWS (Amazon Web Services), Azure, Google, collecting the EOL/EOS data, and storing, maintaining, and transforming data of infrastructures in any datacenter or organization.

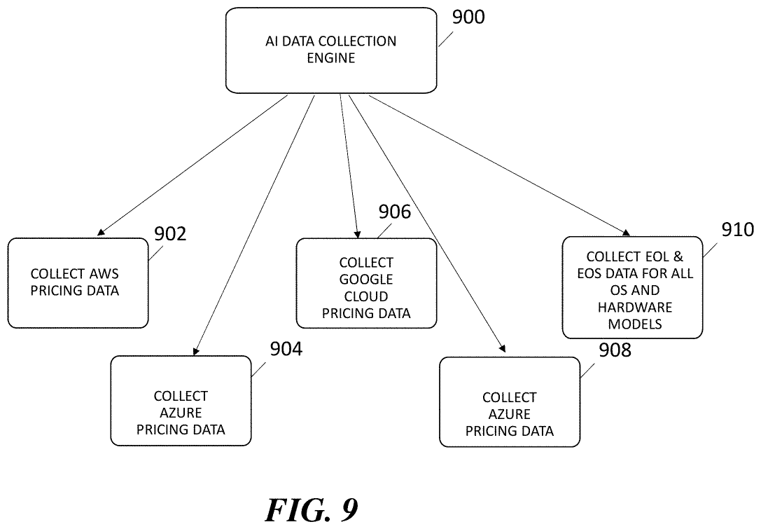

Referring to FIG. 9, the analytic engine 100 includes an AI (Artificial Intelligence) data collection engine 900 that is used to collect data from various cloud vendors. The AWS pricing data is collected for all different server options, storages for all regions, as shown in 902. Similarly, the Azure pricing data is collected for all different server options, instance types, storages for all regions as shown in 904. In block 906, pricing data (e.g., Google Cloud) is collected for all different server options, instance types, storage for all regions. In block 908, a search engine such as Google is used to collect pricing data for all different server options, instance types, storage for all regions. Finally, the AI data collection engine 900 also collects the End of Life and End of Support data from multiple sources for all OS types and hardware models, as shown in 908.

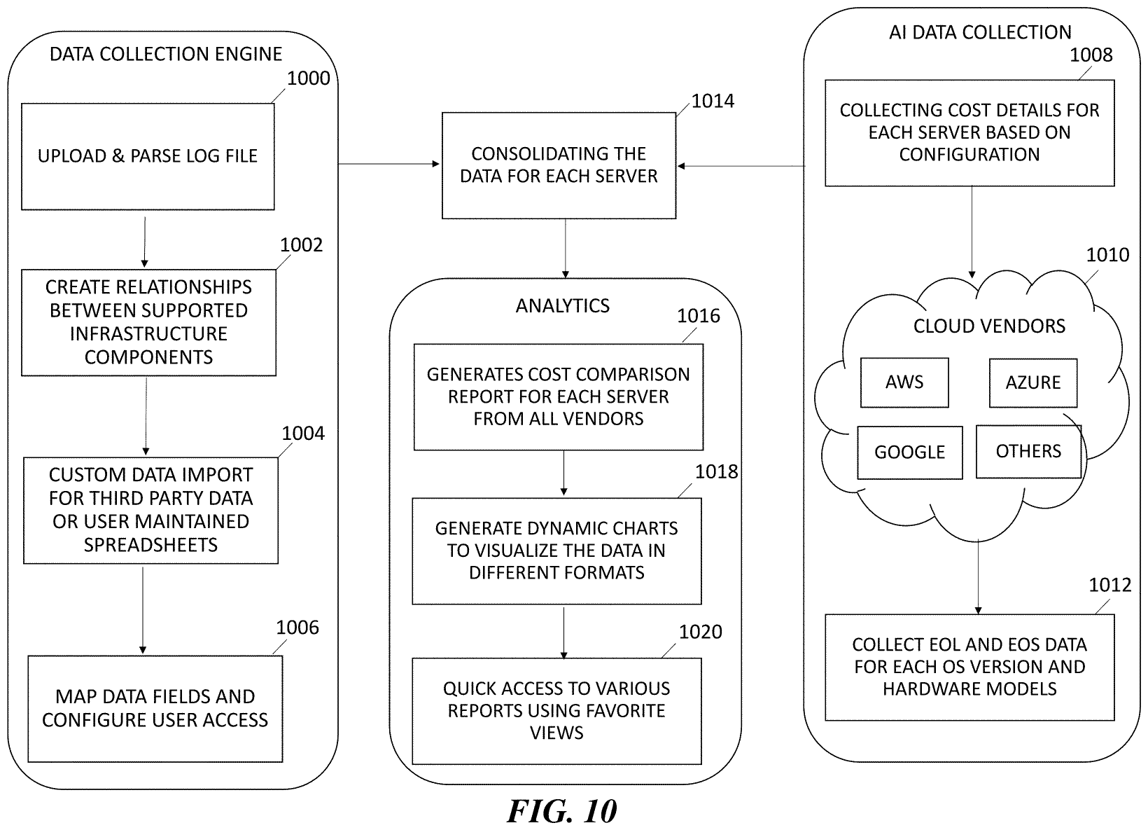

Referring to FIG. 10, a process of pricing data collection is shown. In block 1000, a log file is uploaded. The text in the log file is parsed and unstructured text is converted to structured text, as shown and then it creates relationships between different infrastructure components like servers, switches and storage, etc. that are connected to each other, as shown in block 1002. For data that are available in spreadsheets or other third-party data, the custom data import method is used to collect those data as shown in block 1004. The custom data are used to map to other data collected from the log files, as shown in block 1006. This method then uses the AI data collection engine to collect pricing data from various cloud vendors 1010 (e.g., AWS, Azure, Google, and other cloud vendors) based on server configuration, as shown in block 1008. The method also collects the EOL/EOS data from multiple vendor sources for all operating system types and hardware models, as shown in block 1012. The data collected using data collection engine and AI data engine are used to create relationships for all servers available, as shown in block 1014. The analytic engine analyzes the collected data (cloud vendors pricing data, EOL/EOS and data collected from log files) and generates the cost comparison report. This report is for the comparison of infrastructure pricing between multiple cloud vendors, as shown in block 1016. The analytics method also helps to generate various dynamic charts according to the needs of the users as shown in block 1018. The analytics method also has an option to save the frequently accessed reports as favorite views and able to access the report quickly as shown in block 1020. The favorite views and dynamic charts are described in more detail below.

Automatic Data Migration & Disk Mapping

Data migration is the process of selecting, preparing, extracting, and transforming data and permanently transferring it from a first computer storage/server system to a second computer storage/server system. The data migration process also includes the validation of migrated data for completeness and the decommissioning of legacy data storage. As shown in FIG. 11, a company may desire to migrate its data from a source infrastructure system 1100 to a destination infrastructure system 1102, where the systems 1100 and 1102 may be connected via a computer network 1104. The systems 1100 and 1102 may each include block storage, network attached storage (NAS), storage area networks (SAN), servers, etc. The computer network 1104 may include any one or more of information distribution network(s), of any type(s) or topology(s), alone or in combination(s), such as internet(s), intranet(s), cloud(s), LAN(s), WAN(s), and may incorporate any one or more of cable, fiber, satellite, telephone, cellular, wireless, etc. The company may want to migrate its company data for a number of reasons. The company's operations may be experiencing rapid expansion that its use of computing and storage resources is reaching their upper limits. The company may desire to reorganize or better manage the manner in which its data is stored in the storage devices either onsite, in one or more remote locations, in the cloud, or a combination of physical and virtual storage. The company may want to upgrade and update its computer hardware and software. The company may want to free up resources in its data center or discontinue use of certain data center resources. For a variety of reasons, data migration is a non-trivial matter that can be a time-consuming and costly process that has a low tolerance for errors. The infrastructure migration may be physical to virtual, virtual to virtual, storage block, virtual to cloud, or file migration.

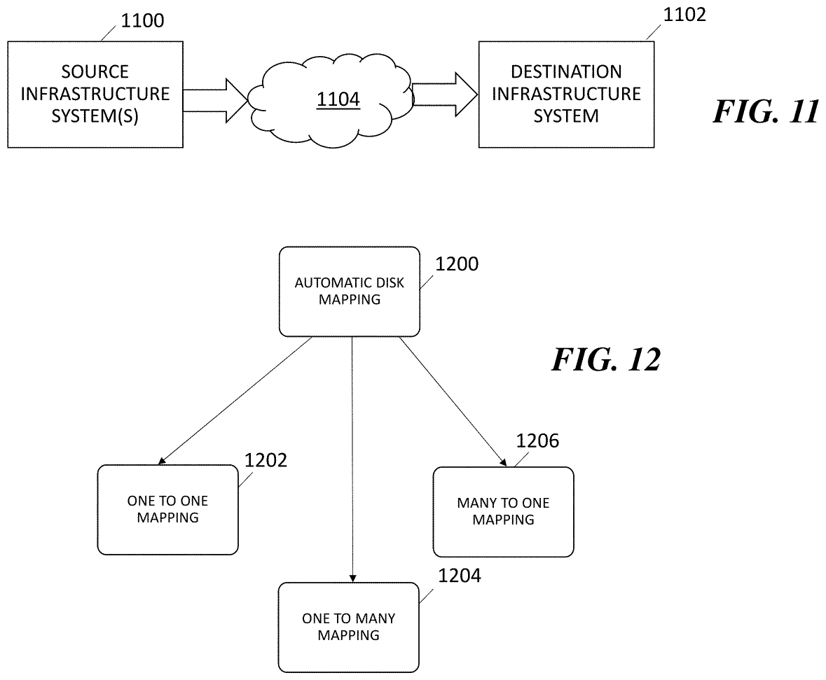

Referring to FIG. 12, the system and module include an automatic migration disk mapping module and user interface 1200. The system or module possess multiple disk mapping methodology such as One-to-One mapping 1202, One-to-Many mapping 1204, Many-to-One Mapping 1206 to accommodate all possible options of disk mapping.

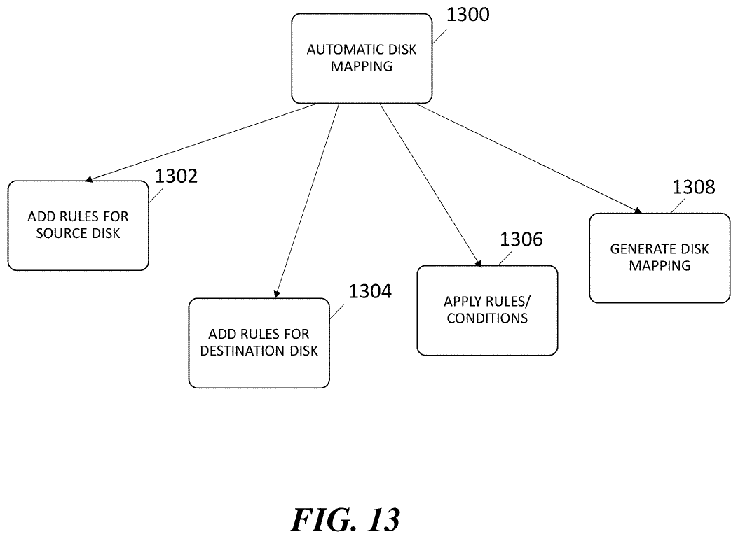

Referring to FIG. 13, the system and method include an automatic migration disk mapping module and user interface 1300. The user is requested to create rules to identify the source disk from which data needs to be migrated. The rules can be built based on multiple criteria such as array serial number, array WWN, etc., as shown in block 1302. Similarly, the user creates rules to identify the destination disks to which data needs to be migrated. The rules can be built based on multiple criteria such as array serial number, array WWN, buffer size, etc., as shown in block 1304. In block 1306, the analytic engine applies the rules for identifying the source and destination disks. The analytic engine then automatically generates the source to destination disk mapping based on the source disk rules 1302 and destination disk rules 1304, and prepare a report for the source to destination mapping, as shown in the block 1508.

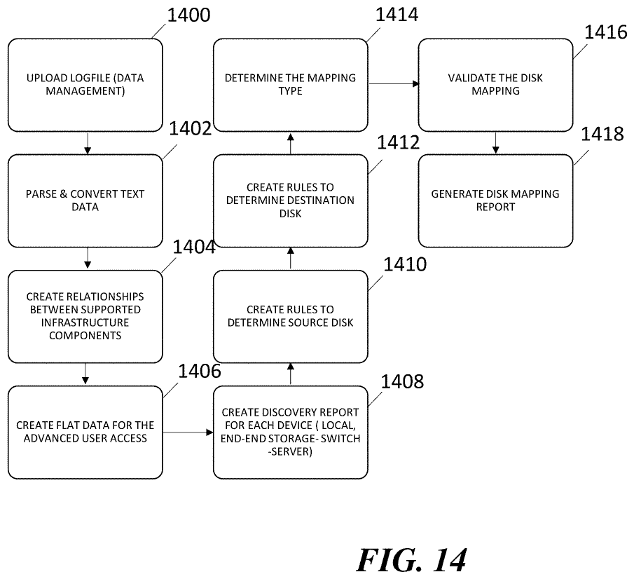

Referring to FIG. 14, a method to import company system configuration data in preparation of migration disk mapping is shown. In block 1400, a log file is uploaded. The text in the log file is parsed and unstructured text is converted to structured text, as shown in block 1402. The method then creates relationships between source and destination infrastructure components that are supported, as shown in block 1404. Flat data is then created for the advanced users, as shown in block 1406. Unstructured data from commands converted to structured data with relationship which advanced user can use for deep analysis. The method then creates a discovery report for each source infrastructure device, as shown in block 1408. The user then creates the rule to identify the source disk, as shown in block 1410. In block 1412, the user creates the rule to identify the destination disk. The user selects the mapping type as the disk mapping can be done by One-to-One, Many-to-One, One-to-Many, as shown in block 1414. The analytic engine automatically generates the disk mapping based on the rules applied for source and destination. The user then validates the disk mapping, as shown in block 1416. The analytic engine then generates the disk mapping report, as shown in block 1418.

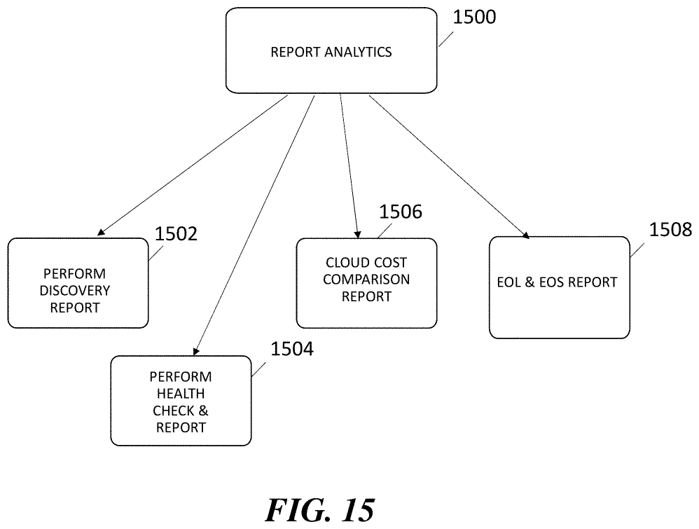

Referring to FIG. 15, the analytic engine includes a report module and user interface 1500. Log files and custom data files are used to identify the infrastructure devices, and discovery reports providing summaries and details of the discovery procedure are available, as shown in block 1502. The report module 1500 is also configured to perform a health check of the infrastructure and generate a health-check (configurable specific to customer) report, as shown in block 1504. The report module 1500 is also configured to compare the configuration of the server with multiple cloud service vendors and provide operating costing information, as shown in block 1506. The report module 1500 is also configured to provide the End of Life and End of support data for all servers and hardware models, as shown in block 1508.

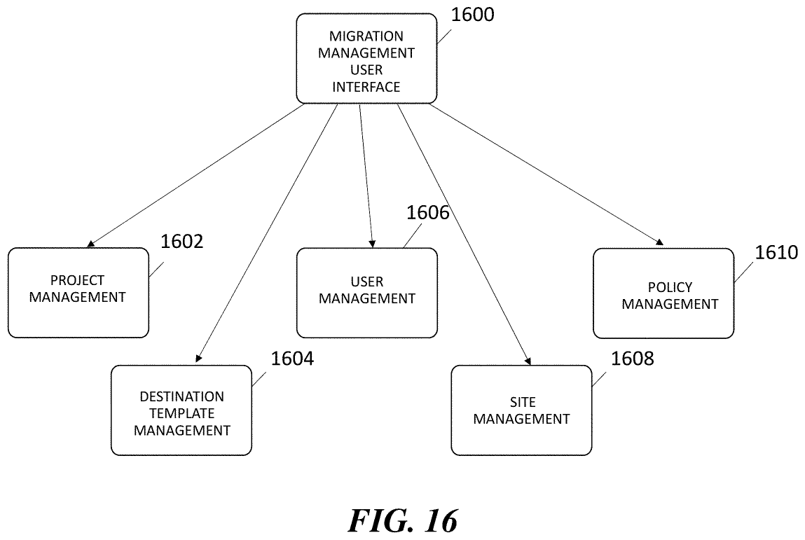

Referring to FIG. 16, the analytic engine includes a migration management user interface 1600 that is configured to enable the user to perform tasks associated with project management, destination template management, user management, site management, and policy management. For project management 1602, user has option to add user, custom fields, choose data type and automation specific to each project. For destination template management 1604, the user may enter and add information about the destination infrastructure. For user management 1606, the user interface enables the user to specify users who may access the migration information and their access privileges. For site management 1608, offers user to restrict data access for each user which site and what level they can access. For policy management 1610, restricts functional access for authenticated sites, it restricts what user reports, edits within the site they have access to.

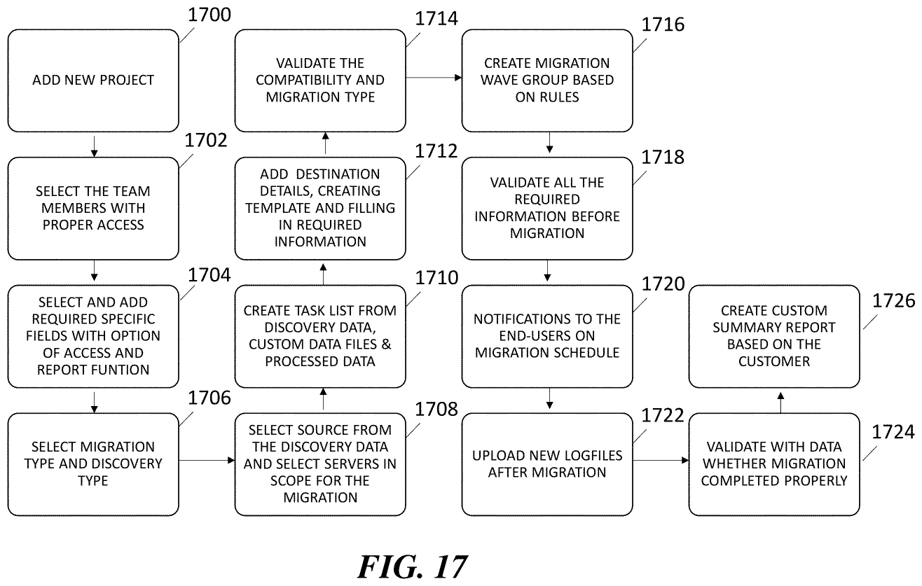

Referring to FIG. 17, an exemplary method of the present disclosure includes the step of adding a new project via the user interface, as shown in block 1700. The new project may be identified by a name and other attributes. The user may then enter or select team members who will work on the migration project and specify their roles and access privileges, as shown in block 1702. The user may also specify data fields that are required for the user management function, as shown in block 1704. The user may also select the migration type and discovery type, as shown in block 1706. The user may then select the source infrastructure devices from the automated discovery data/report and select servers that are within the scope of migration, as shown in block 1708. The analytic engine may automatically create a migration task list with customary data fields using information in the discovery data/report, third-party custom data files, and processed data, as shown in block 1710. The user may add more details about the destination infrastructure system and creating templates and filling in further information that is required, as shown in block 1712. In block 1714, the analytic engine may automatically validate the compatibility of the destination infrastructure and the selected migration type. The analytic engine may further create migration wave groups based on specified rules, as shown in block 1716. The analytic engine further automatically validates all the required information before migration begins, as shown in block 1718. Notification is then automatically sent to the end users to inform them of the migration schedule, as shown in block 1720. Migration is then carried out, and post-migration log files are collected automatically, as shown in block 1722. The resultant data is then used to validate whether migration has been completed properly, as shown in block 1724. A custom summary report of the migration may then be automatically generated, as shown in block 1726.

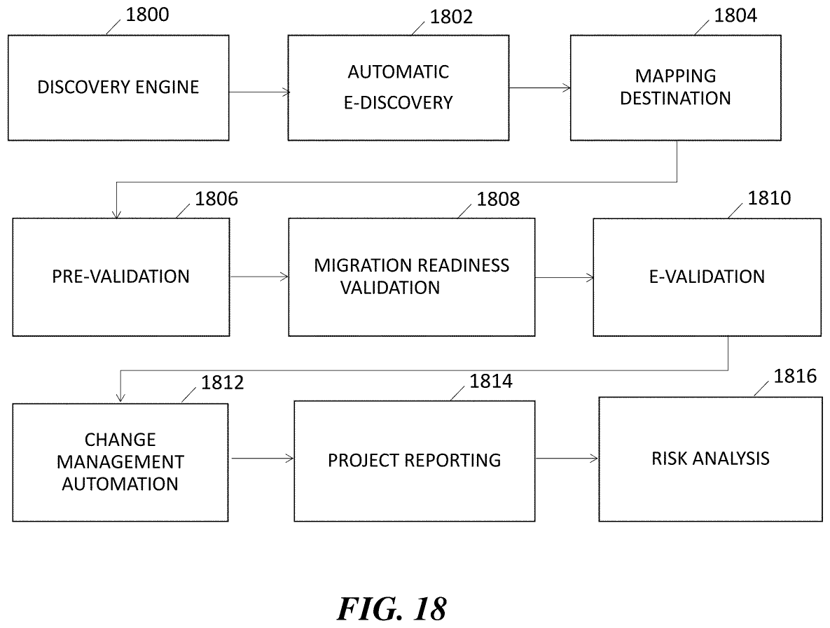

Referring to FIG. 18, the analytic engine for computer data migration using an automatic computer system infrastructure analytic engine includes using a discovery engine 1800, that uses scripts to automatically survey, determine, and collect information on the servers in the source infrastructure system that are within the scope for data migration, including their capacities and operating status. The log files consist of information collected on VMAX, VNX (Block), VNX file, Netapp, 3par, Cisco Switch, Brocade switch, AIX, Solaris, Linux, Windows, VMWare, HPUX, Nutanix, Isilon, xTermIO, HDS, Pure, Vplex, etc. The use of log files means no agents are required to collect this information. The data storage devices that are within the scope of the migration project are first identified. Then all of the computer servers that are connected to those data storage devices are discovered. The analytic engine further performs e-discovery 2002 to automatically detect changes in the hardware and software environment of the source infrastructure system including servers, switches, their capacity, operating status, etc. The resultant information is validated against the log files and system data is updated. In block 1804, the analytic engine is configured to automatically determine the requirements for the destination infrastructure system based on knowing the source infrastructure system configuration, and automatically and intelligently map source to the destination based on the business needs of the company, the requirements of the software, and the destination configurations. A pre-validation step 1806 further automatically checks for compatibility of the mapping from source to destination, and also validates the mapping according to industry best practices and customer-specific specifications. An intelligent migration method is then selected and recommended for the migration process. An option is to prioritize supported migration methods based on the business need, recommended method is chosen based on the priority and business impact. The analytic engine further performs a migration readiness validation by validating the provisioning of the destination infrastructure components, as shown in block 1808. The analytic engine also enables users to manage change management approval and notification settings so that application owners can track and receive notification. The analytic engine also generates automatic scripts for data migration. In block 1810, an e-validation step is performed to validate the status of the migration and the various settings and clean-up, if needed. Automated change management 1812 is also performed to digest information from the configuration management database and change management systems. The analytic engine further automatically generates documents required for change management, and track status and notifications. A project reporting module or step 1814 enables end-to-end project management using just a single tool, and customizable project status reports can be generated based on real data. A project risk analysis module or report 1816 provides the status of the migration based on the set target date, and risk analysis may be performed based on change approvals, environment readiness resource allocation.

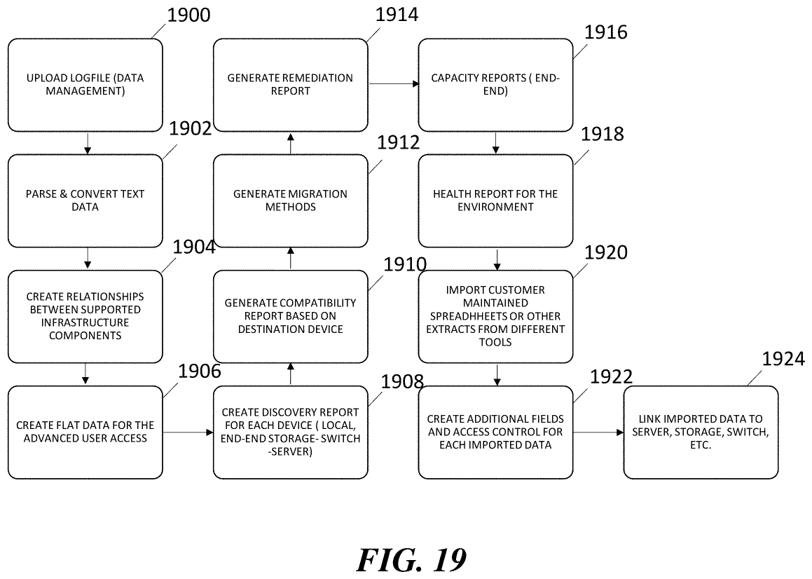

Referring to FIG. 19, a method to import company system configuration data in preparation of migration is shown. In block 1900, a log file is uploaded. The text in the log file is parsed and unstructured text is converted to structured text, as shown in block 1902. The automated migration planning method described herein are designed to reduce the complexity of data capture process and eliminates the risk of human error by automating the process. By automating the collection of data describing the customer computer infrastructure from log files, the analytic engine eliminates the complexity of data capture and reduces the risk of human errors. The log files are prepared automatically by running data collection scripts or programs on the source infrastructure system to survey and collect configuration and sizing information of the servers, storage devices, and switches. Because this data collection process is automated, human operator involvement is minimized. Further, mistakes due to operator error are also greatly reduced. Once information about the source infrastructure has been captured by log files, they can be simply uploaded to be used to plan the migration process. From the log file, a database is automatically created by the system and method to store information that will be used to plan and carry out the migration process. The migration management database may include data fields that contain, for example, name, serial number, and IP address of servers, storage devices, and switches. Each migration project is also assigned a project name. A user may make changes (e.g., add or edit) to the data fields (e.g., row and column) in the database using a graphical user interface that facilitates the editing process. The method then creates relationships between source and destination infrastructure components that are supported, as shown in block 1904. Flat data is then created for the advanced users, as shown in block 1906. Unstructured data from commands converted to structured data with relationship which advanced user can use for deep analysis. The method then creates a discovery report for each source infrastructure device, as shown in block 1908. A compatibility report is also generated based on the destination infrastructure devices, as shown in block 1910. For example, the method identifies and verifies, across the servers, switches, and storage, what software is needed to for the destination infrastructure system, sufficient resources are available to support the migration, multipathing, volume manager, HBA, software, patches, OS, cluster validation, shared disk validation, etc. The method identifies and recommends a migration method(s) based on the company's business requirements and the nature of the source and destination devices, as shown in block 1912. For example, the method may recommend a host-based migration or storage-based migration. A remediation report is generated, as shown in block 1914. Further, a capacity report is generated, as shown in block 1916. A health report for the environment is also generated, as shown in block 1918. This report validates captured data against the industry best practices and specific best practices with the option to show in different color codes based on the criticality. The company's system configuration data that may have been generated by other tools are also uploaded or imported, as shown in block 1920. The customer infrastructure data may be in a number of predetermined log file formats, such as CSV (comma-separated values) and XLS (Microsoft Excel) formats. The method then generates additional fields and specifies access control rules for the imported data, as shown in block 1922. The imported data is then linked to the servers, switches, etc. in the source infrastructure system, as shown in block 1924.

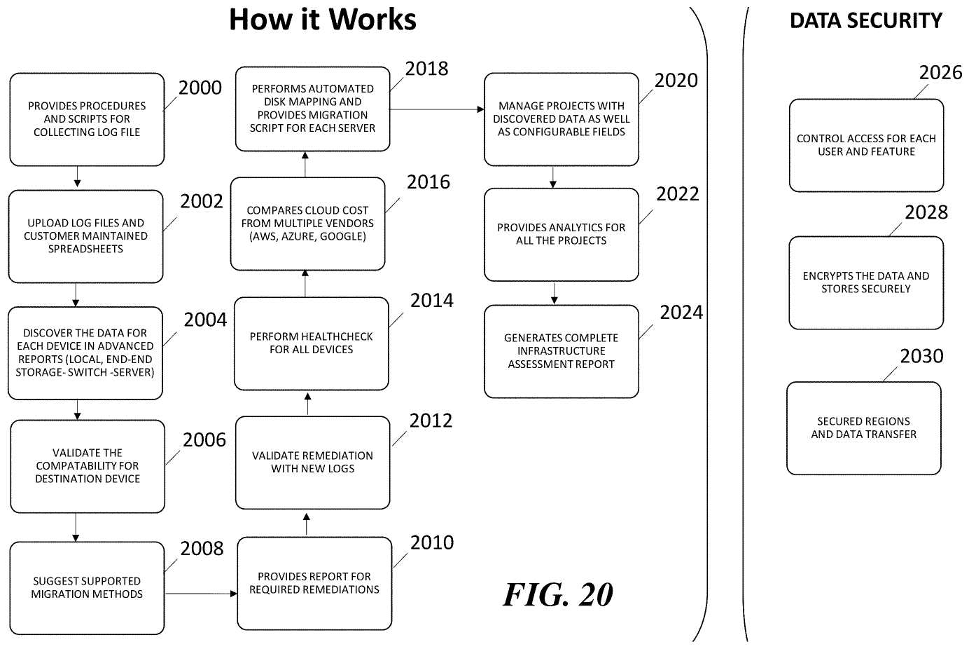

FIG. 20 is a more detailed flow diagram of the process. In block 2000, procedures and scripts for collecting log files are provided. In block 2002, log files and customer data (in the form of spreadsheets and other formats) are uploaded. Data pertaining to each device are generated and reported, such as end-to-end reports for local server, storage, and switches, as shown in block 2004. Compatibility with the destination devices are automatically validated, as shown in block 2006. Supported migration methods are also automatically suggested, as shown in block 2008. A remediation report is generated, as shown in block 2010. The remediation report is validated with new log files, as shown in block 2012. Further, a health report for the environment is also generated, as shown in block 2014. This report validates captured data against the industry best practices and specific best practices with the option to show in different color codes based on the criticality. In block 2016, pricing cost collected from various cloud vendors are compared. Automated disk mapping and migration script for each server are generated, as shown in block 2018. In block 2020, the migration projects are performed with discovered data. Analytics for the projects are generated and reported, as shown in block 2022. In block 2024, a complete infrastructure assessment report is generated. The analytic engine further includes components to ensure data security, including controlled access for each user 2026, encrypted data 2028, and JSON Web Token (JWT) for secured user access in SSL-enabled regions 2030.

User Experience & Reporting Tools

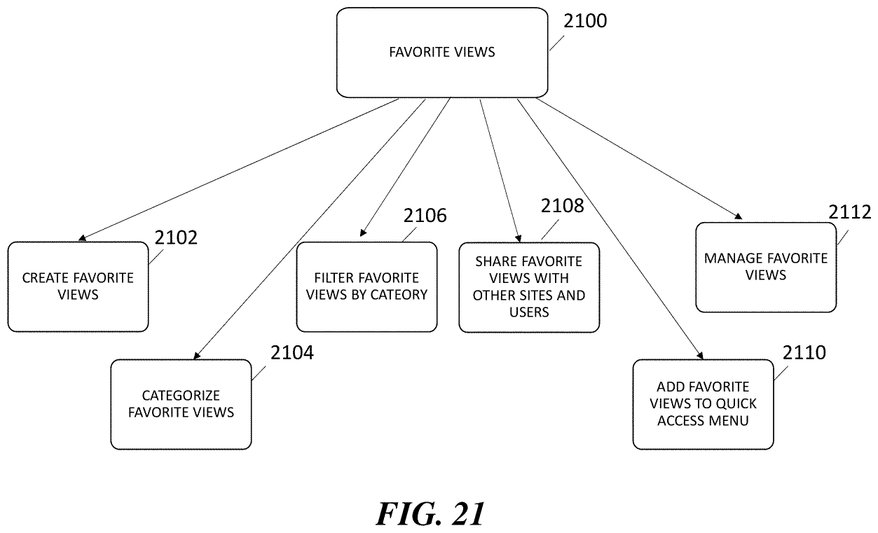

The analytic engine further includes user experience and reporting tools. Referring to FIG. 21, the system and method include favorite view 2100. User can be able to create a favorite view for easy accessing the frequently accessing reports, as shown in block 2102. User can also add category to the favorite views based on business use case, as shown in block 2104. In block 2106, user can filter the favorite view by category for easy access. User can share the favorite view to other users and other site hosted in system or method, as shown in block 2108. In block 2110, User can also move the favorite views to quick access menu. User will be able to manage the favorite view shared to other users and sites, as shown in block 2112.

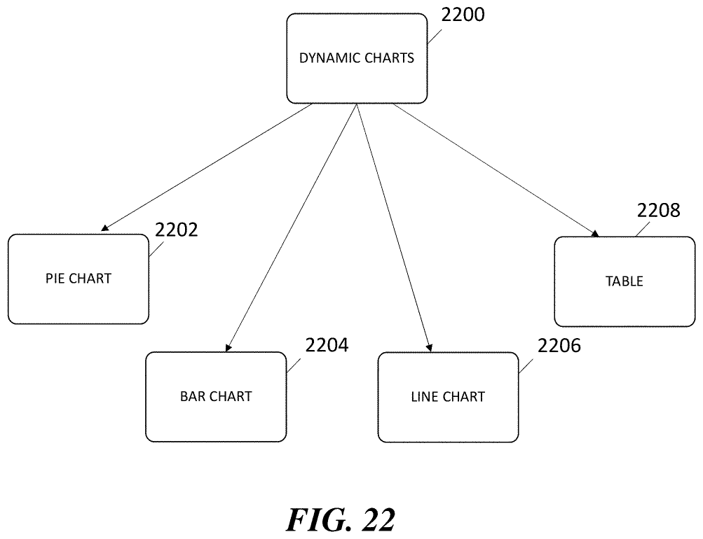

Referring to FIG. 22, the system and method include dynamic charts 2200. User can be able to create different types of charts such as pie chart 2202, bar chart 2204, line chart 2206 and table 2208.

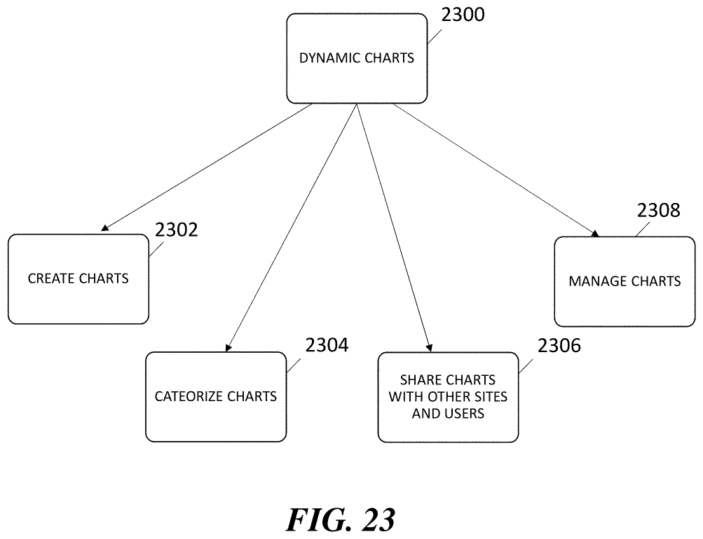

Referring to FIG. 23, the system and method include dynamic charts 2300. User can create dynamic charts, as shown in block 2302. User can also add category to the charts based on business use case, as shown in block 2304. User can share the charts to other users and other site hosted in system or method, as shown in block 2306. In block 2308, User will be able to manage the charts shared to other users and sites.

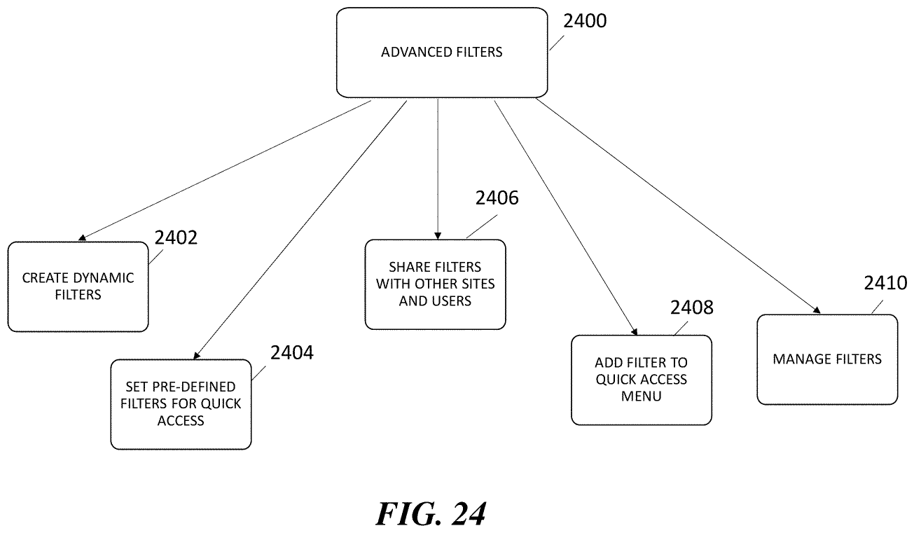

Referring to FIG. 24, the system and method include advance filter 2400, where user can be able to create various migration specific reports such as discovery, migration method, Compatibility, etc. Advanced filter helps the user to report data using various combinations like Projects, Third Party data, OS, HW model etc. User can be able to create a dynamic filter, it shows the relevant category, subcategories based on user selection, as shown in block 2402. In block 2404, user can save advance filter to favorite view for easy access. User can share the advanced filter to other users and other site hosted in system or method, as shown in block 2406. In block 2408, User can also move the advanced filter to quick access menu. User will be able to manage the advanced filter shared to other users and sites, as shown in block 2410.

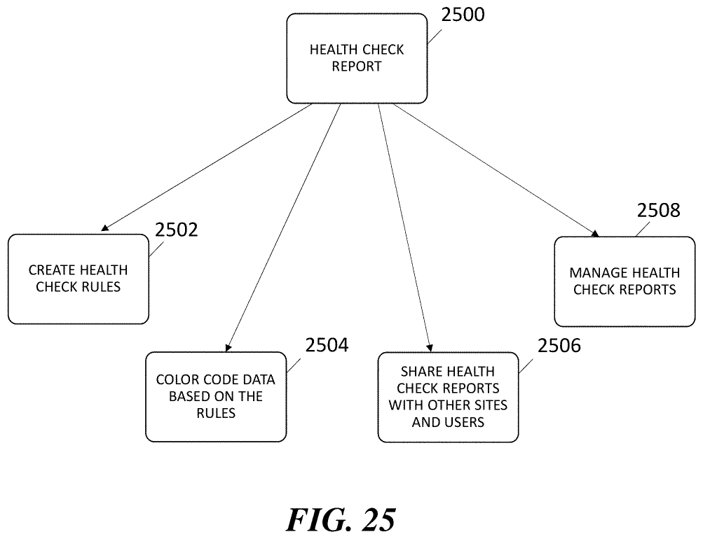

Referring to FIG. 25, the system and method include health check 2500, where user can be able to create various color coding to differentiate the health condition of the infrastructure devices. User can be able to create dynamic rules, as shown in block 2502. In block 2504, user can assign rules to color coding and the system or method will be generating the health check report with the color coding. User can share the health check report to other users and other site hosted in system or method, as shown in block 2506. In block 2508, user will be able to manage the health check report shared to other users and sites.

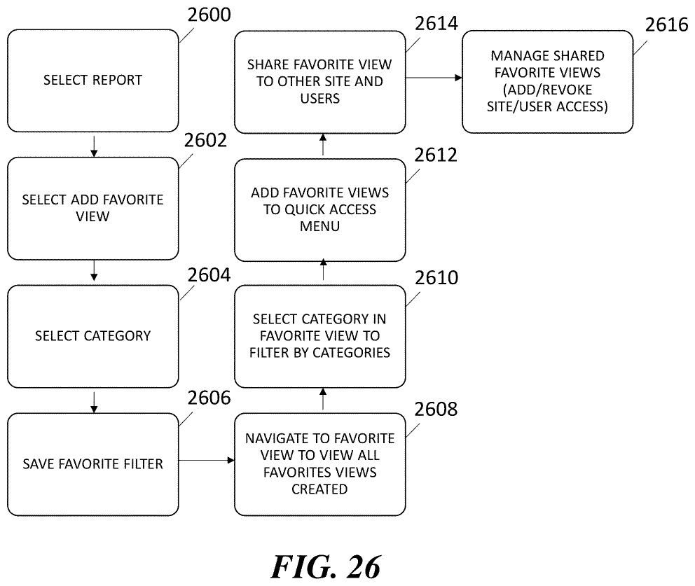

Referring to FIG. 26, a method to create favorite views is shown. In block 2600, report is selected. The report can be discovery, migration method, compatibility, etc. In block 2602, the user selects the add favorite view. User then chooses the optional category, based on the business use case, as shown in block 2604. User then saves the favorite view, as shown in block 2606. In block 2608, User navigates to the favorite view section of the user interface to view all the saved favorite views. In block 2610, user select the category in the favorite view section in user interface to filter for the favorite view only for the chosen category. User can move the frequently used favorite view to quick access menu to easy access, as shown in block 2612. User can share the favorite view to other users and other site hosted in system or method, as shown in block 2614. In block 2616, user will be able to manage the favorite view shared to other users and sites.

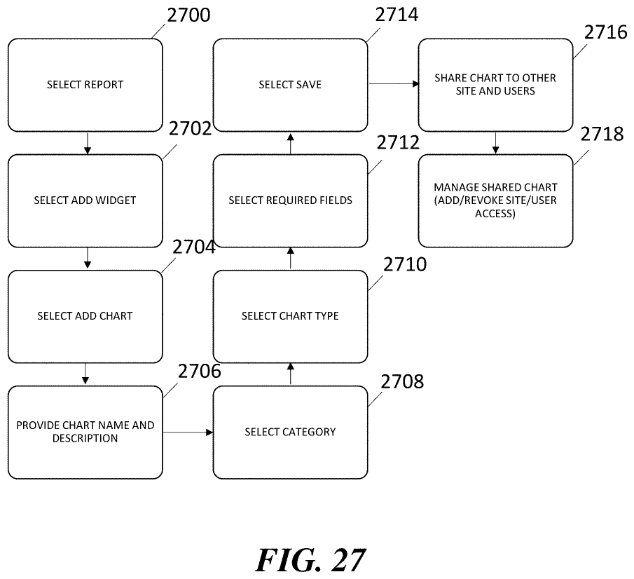

Referring to FIG. 27, a method to create dynamic chart is shown. In block 2700, report is selected. The report can be discovery, compatibility, migration method, etc. In block 2702, the user selects the add widget. In block 2704, User the selects add chart option. User provides name and description for the chart, as shown in block 2706. User then chooses the optional category, based on the business use case, as shown in block 2708. In block 2710, user select the type of chart. The system or method supports pie chart, bar chart, line chart and table. User then select the fields from the selected report to be used in the chart. As shown in block 2712. In block 2714, user saves the chart with all the configurations chosen from the blocks 2706 to 2712. User can share the dynamic charts to other users and other site hosted in system or method, as shown in block 2716. In block 2718, user will be able to manage the dynamic charts shared to other users and sites.

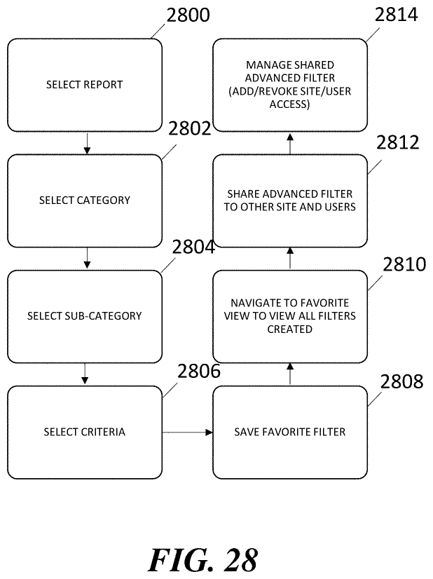

Referring to FIG. 28, a method to create advanced filter is shown. In block 2800, report is selected. The report can be discovery, migration method, compatibility, etc. In block 2802, the user selects the category. The category can be server, switch, storage, projects, third party data sources, etc. The user then selects the sub-category based on the category chosen in block 2802, as shown in block 2804. In block 2806, the user selects one or more criteria based on the category and sub-category chose in blocks 2802 and 2804 respectively. The user then saves the advanced filter with all the configurations chosen from the blocks 2802 to 2806, as shown in block 2808. In block 2810, User navigates to the favorite view section of the user interface to view all the saved favorite views. User can share the advanced filters to other users and other site hosted in system or method, as shown in block 2812. In block 2814, user will be able to manage the advanced filters shared to other users and sites.

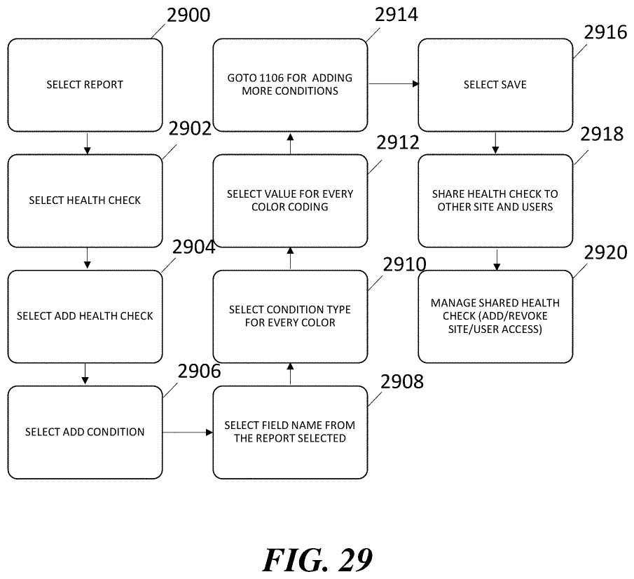

Referring to FIG. 29, a method to create health check report is shown. In block 2900, report is selected. The report can be discovery, migration method, compatibility, etc. In block 2902, user selects the health check option. The user then selects the add health check, as shown in block 2904. In block 2906, the user selects the add condition option. User selects the field name from the report selected in block 2900, as shown in block 2908. In block 2910, user chooses the type of condition for each color coding which can be equals, lesser than, greater than, etc. User then selects value for every color coding, as shown in block 2912. In block 2914, user repeats the block 2906 to 2912 to add more conditions to the health check report. The user then saves the health check report with all the configurations chosen from the blocks 2906 to 2914, as shown in block 2916. User can share the health check reports to other users and other site hosted in system or method, as shown in block 2918. In block 2920, user will be able to manage the health check reports shared to other users and sites.

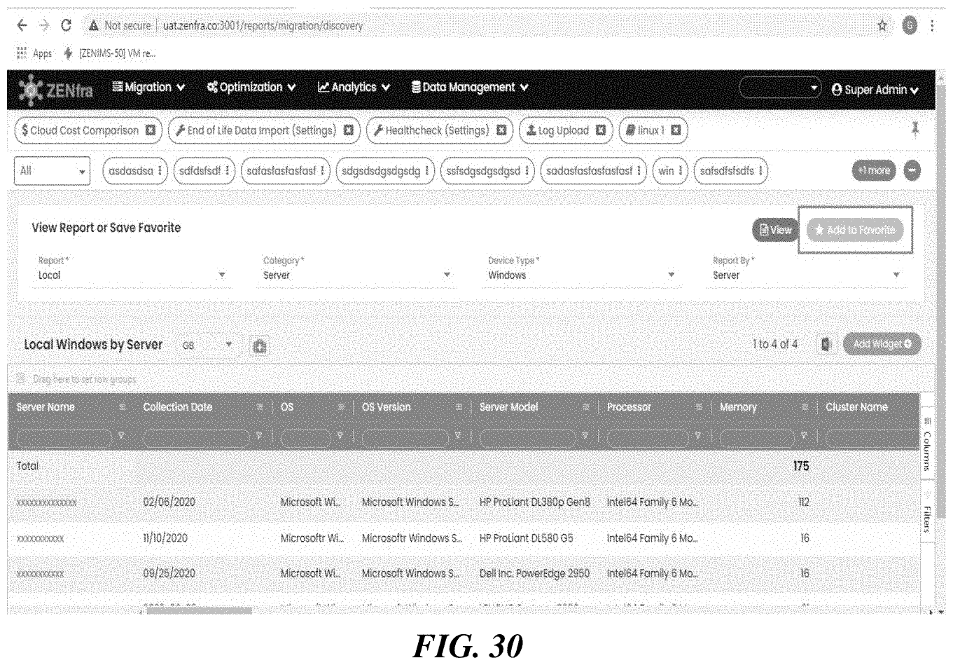

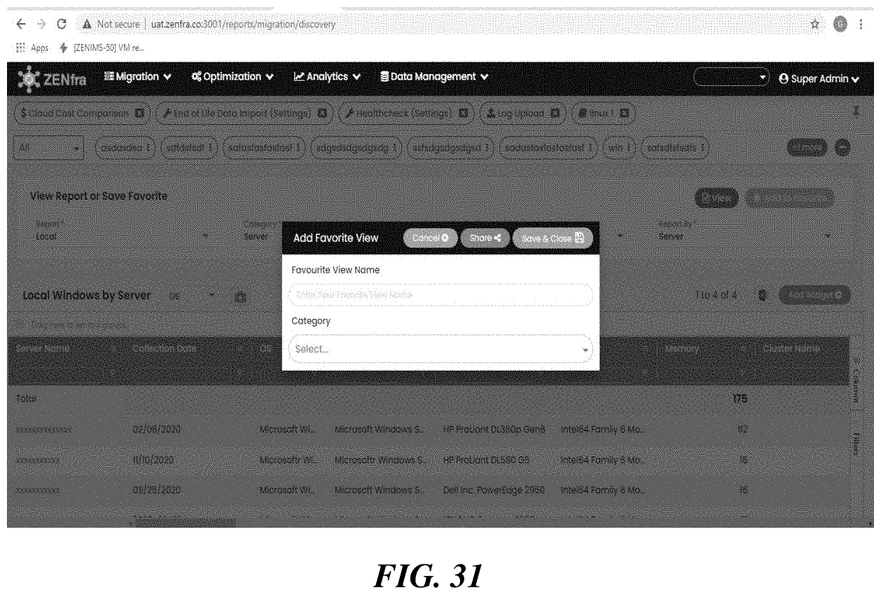

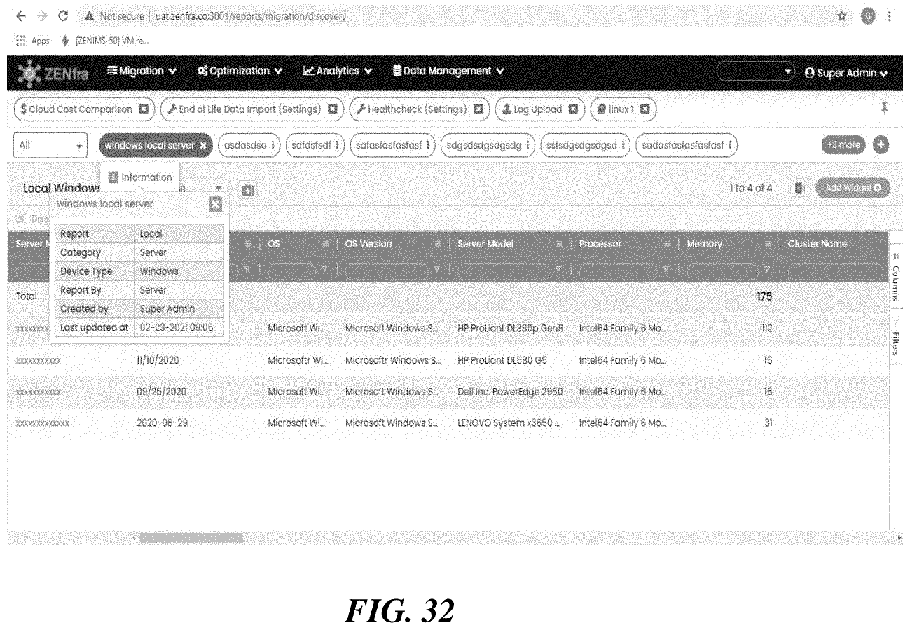

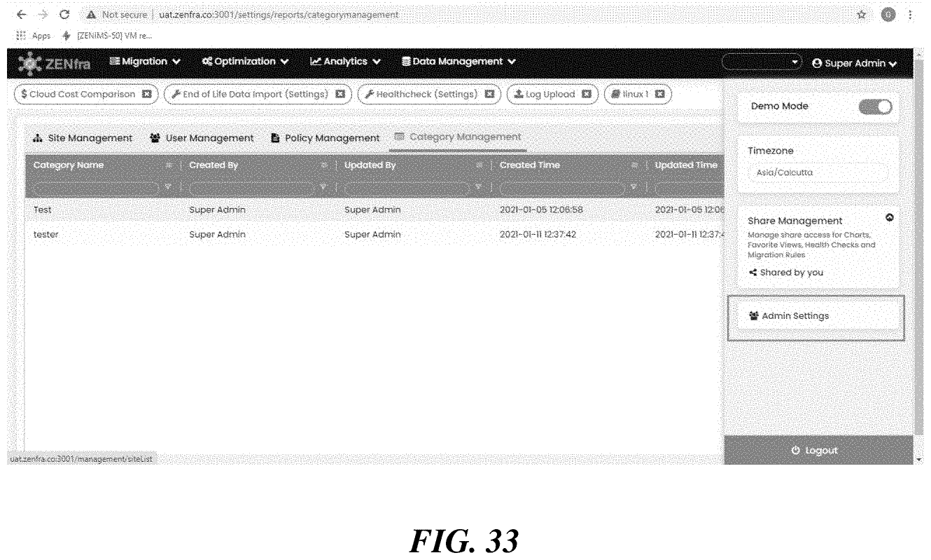

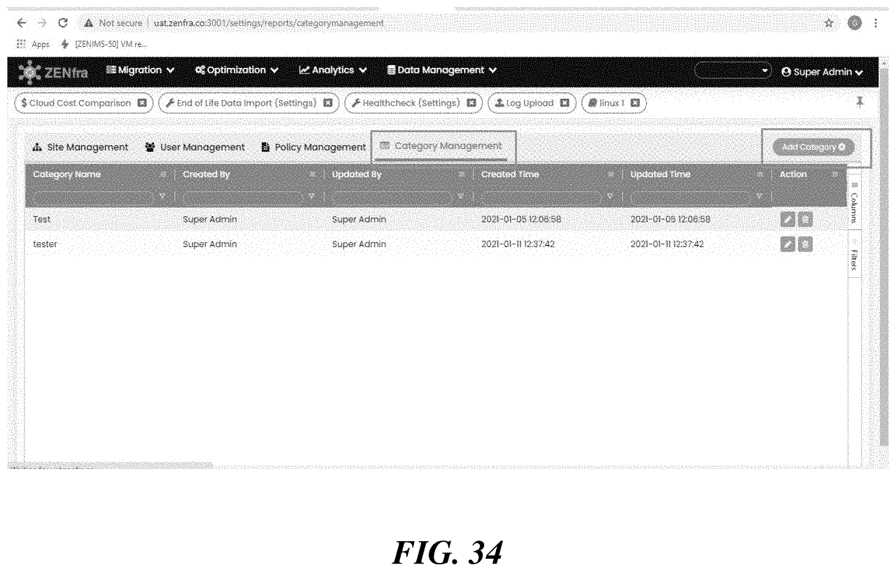

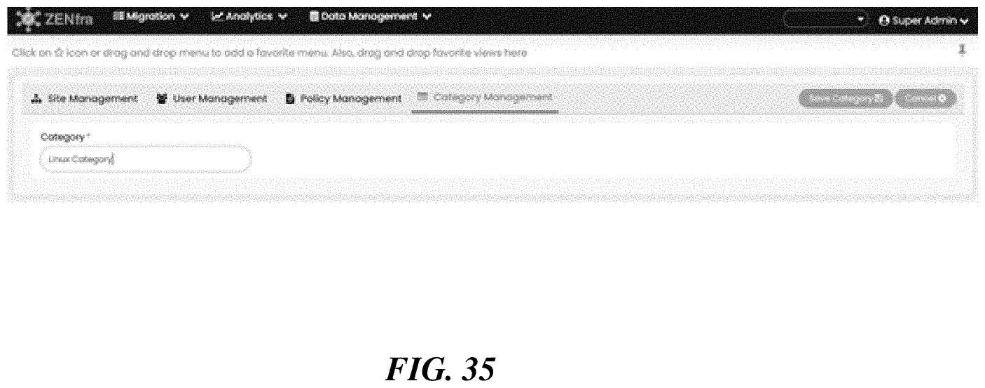

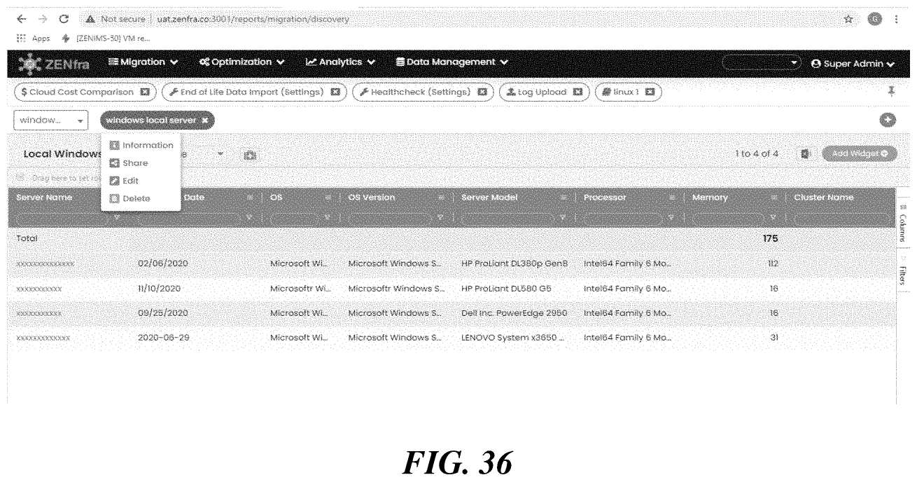

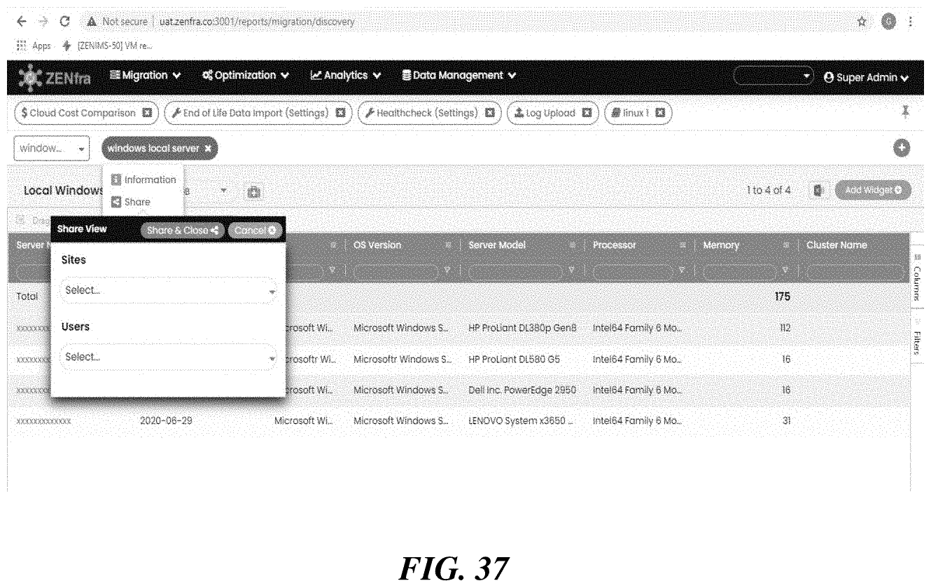

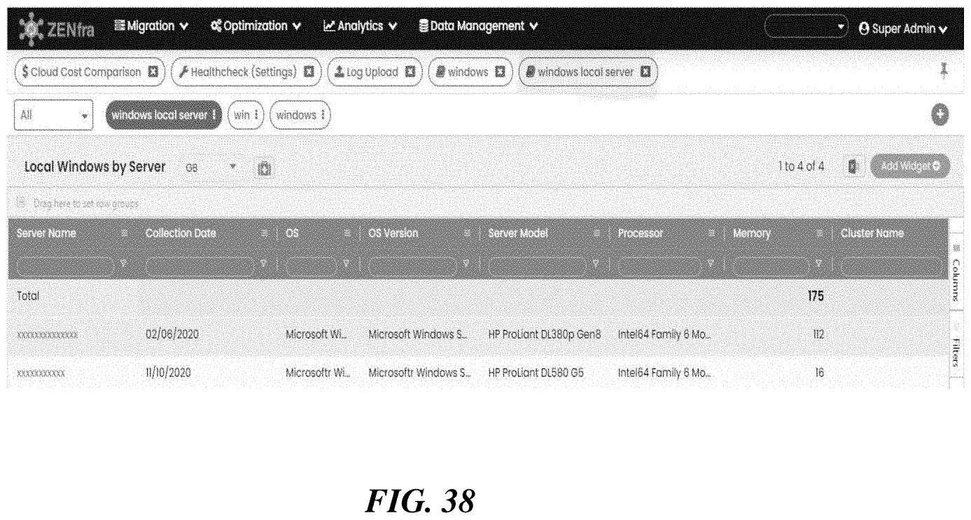

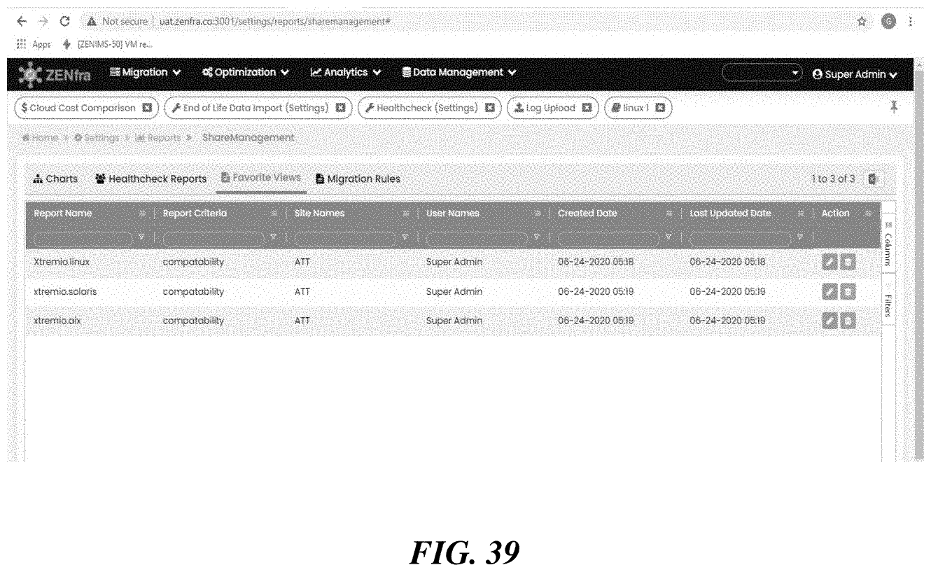

Referring to FIGS. 30-39, which are exemplary screenshots of graphical user interface associated with the favorite view function according to the teachings of the present disclosure. FIG. 30 shows a screenshot showing that a user has elected to save a current view of a report as a favorite view. The existing favorite reports are displayed in a top region of the screen. FIG. 31 shows that the user may enter a unique name for the new favorite view and assign it to a favorite view category. FIG. 32 is an exemplary screenshot that shows that the new favorite view has been successfully created and given the name Windows Local Server Report. The user may click on the “i” icon to cause the user interface to display details related to the new favorite report. FIG. 33 shows that a user may edit the report categories by clicking on “Settings” icon, “Reports” icon, and then “Category Management” in the drop-down menu. FIG. 34 shows the “Add Category” functionality available to the user to add a report category. FIG. 35 shows the ability of the user to select a specific category (e.g., “Windows category”) in the drop-down menu so that only reports in the selected category will be displayed. As shown in FIG. 36, a user may elect to obtain more information, edit, delete, and share a favorite view with other users and sites by entering site and user identifiers, as shown in FIG. 37. As shown in FIG. 38, a favorite view can be added to a quick access menu section by just dragging it to the proper menu section. FIG. 39 shows that a favorite view can be edited and managed by accessing the settings-reports-share management function.

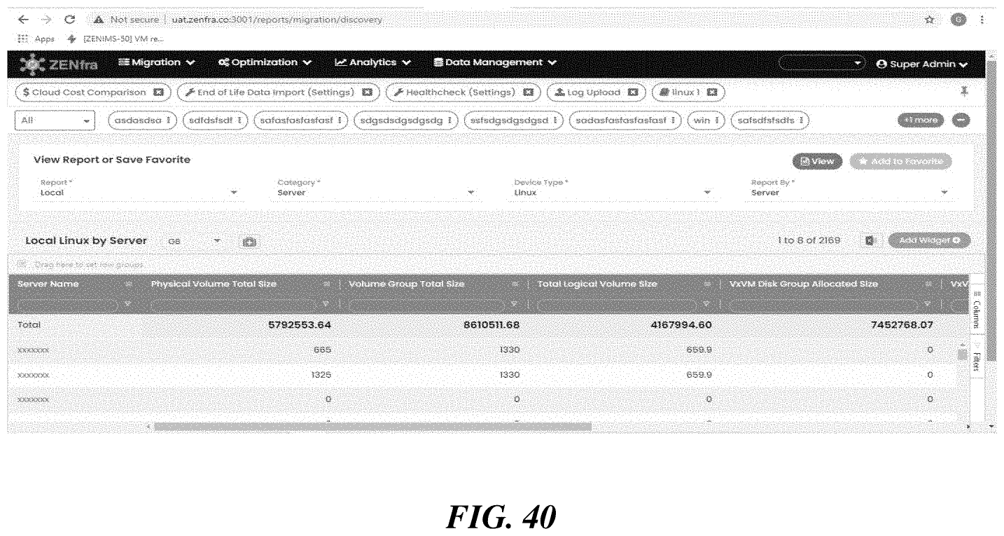

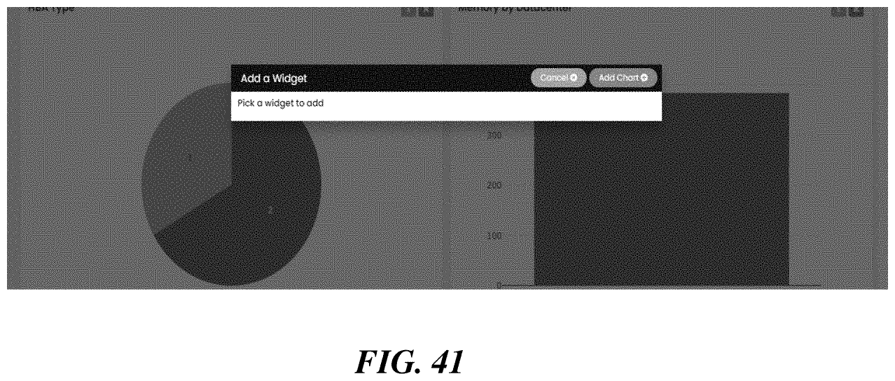

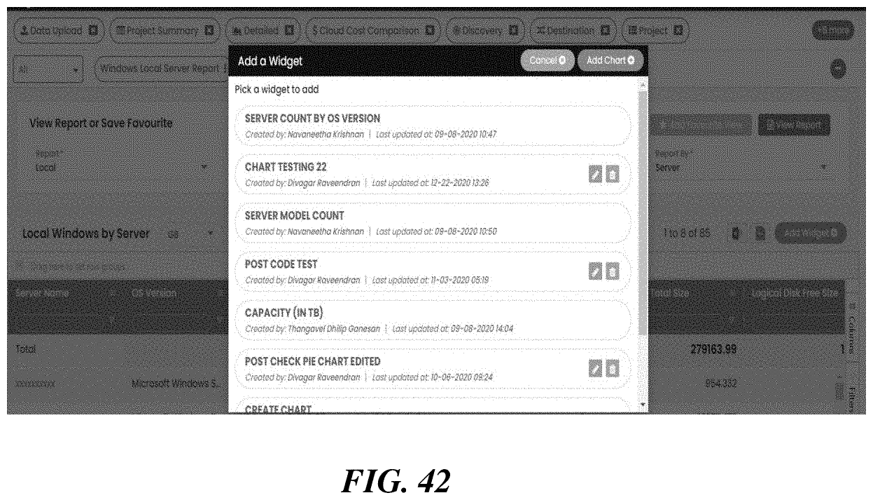

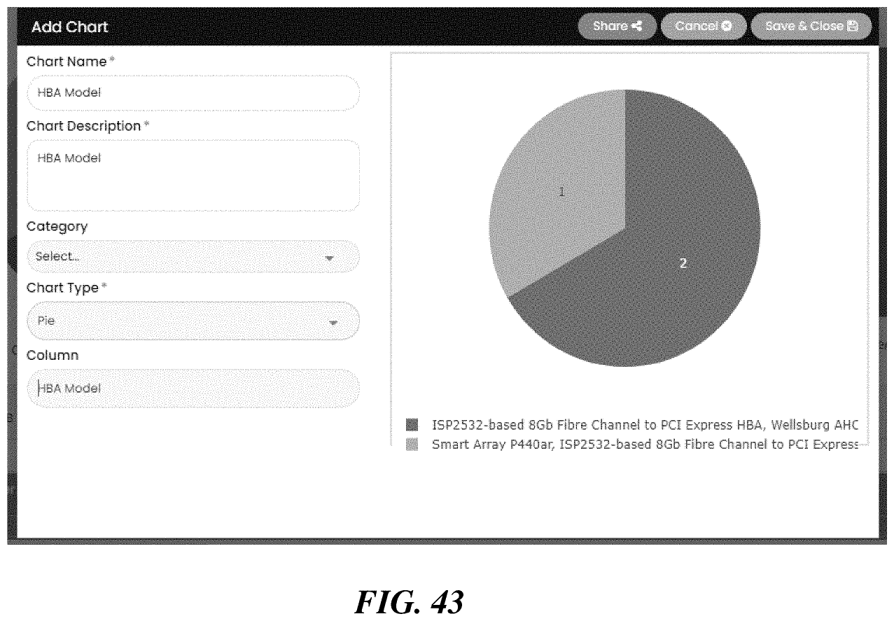

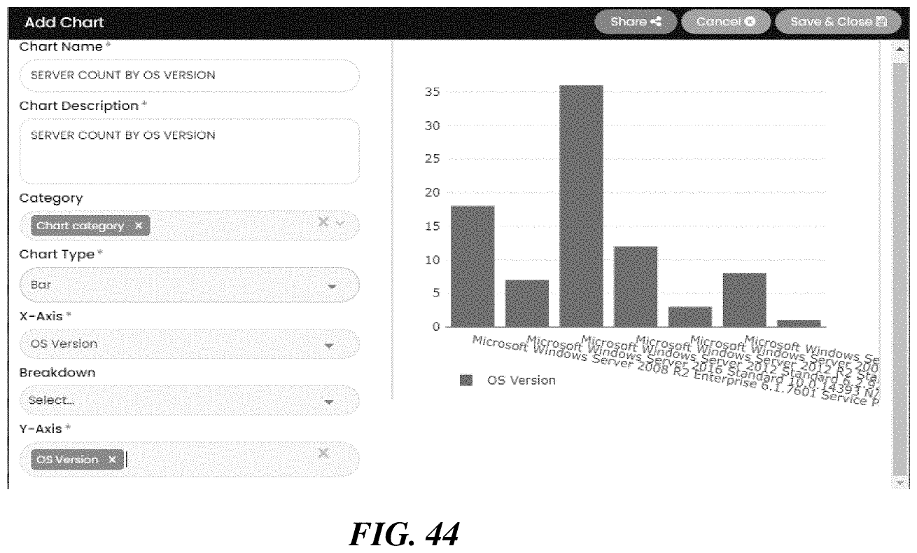

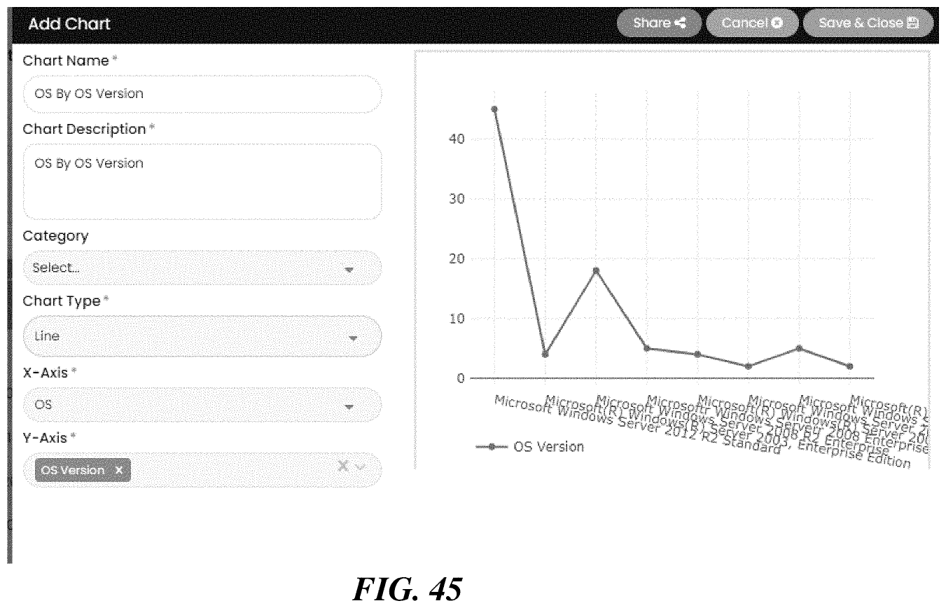

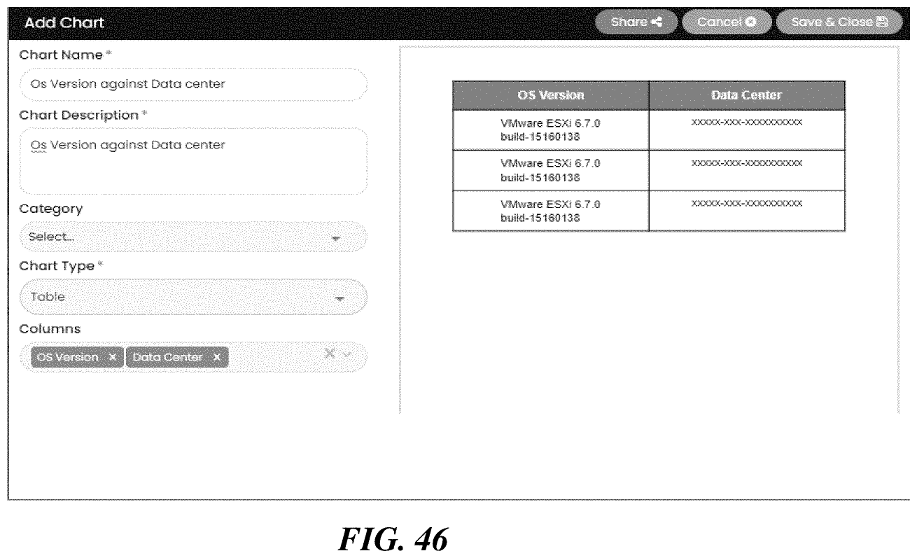

FIGS. 40-46 are exemplary screenshots of graphical user interface associated with the chart function. As shown in FIG. 40, a user may click on the “Add widget” icon on the right-hand side of the screen. The user may then select the “Add chart” option on the next screen, as shown in FIG. 41. On the next screen, as shown in FIG. 42, the chart creation window opens to enable to user to specify creation of a chart. As shown in FIG. 43, the user may enter the chart name, description, category, chart type, and column, and save to save the newly created chart type. The chart type may be pie chart (FIG. 43), bar chart (FIG. 44), line chart (FIG. 45), and table (FIG. 46). Each chart may be assigned to a category and shared with other users/sites, just like the afore-described favorite views.

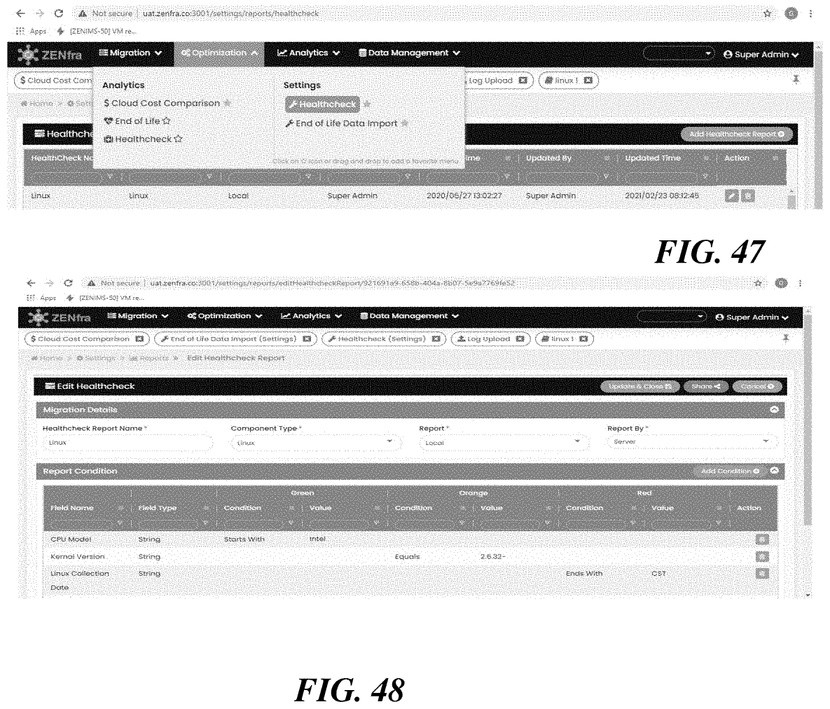

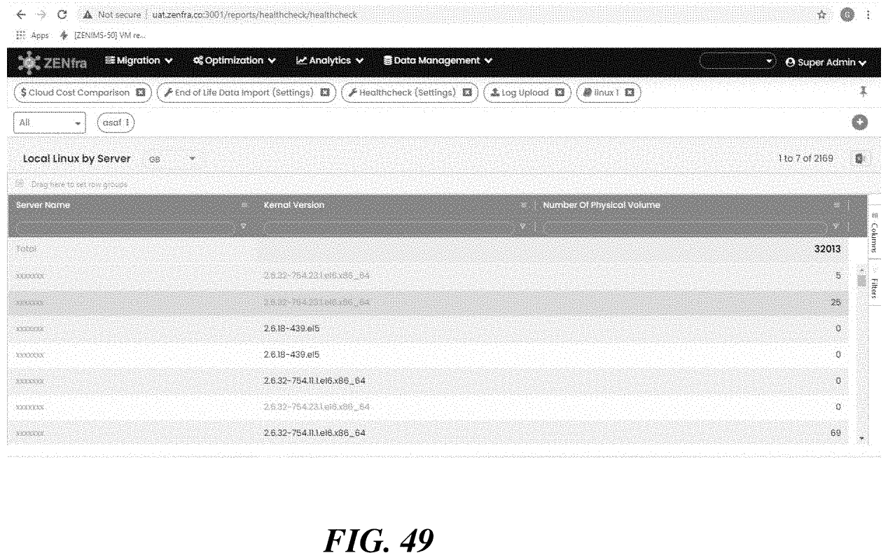

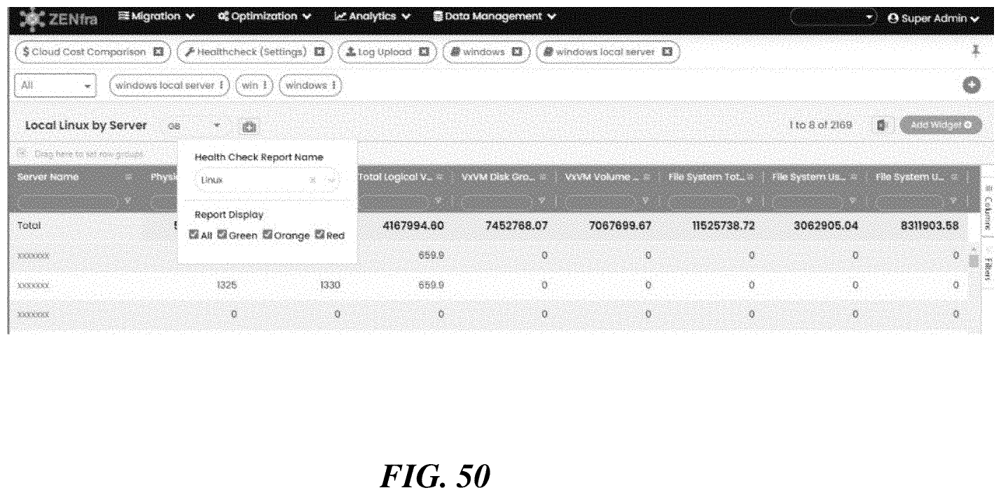

FIGS. 47-50 are exemplary screenshots of graphical user interface associated with the health check report function. In FIG. 47, a user may highlight a section or data set for detailed analysis by using the health check report function to display data based upon the specified condition. A health check report may be created by accessing Settings, Reports, and then selecting Health Check. The user may enter the health check report name, component type and select the report by using a drop-down list to generate the new health check report. As shown in FIG. 48, in the report condition section, the user may add the condition and value for the health check condition. Three health condition values can be coded “Green, Orange, Red” to indicate health alert level, for example. Users can update multiple health condition and value columns based upon their needs. In FIG. 49, a health check report is shown with four health conditions displayed in green. As shown in FIG. 50, the user may filter out conditions by color so that the report will display all conditions, green conditions, orange conditions, and/or red conditions. An existing health check report can be shared with other users and/or sites. An existing health check report can also be edited or modified as needed.

The features of the present invention which are believed to be novel are set forth below with particularity in the appended claims. However, modifications, variations, and changes to the exemplary embodiments of the exemplary system and method described above will be apparent to those skilled in the art, and the described herein thus encompasses such modifications, variations, and changes and are not limited to the specific embodiments described herein.

What is claimed is:

1. An automated infrastructure cost optimization method comprising:
executing a script configured to collect information about at least one component of an infrastructure and generating a log file describing the at least one component;
receiving a custom file specifying application and static information at least one additional component in the infrastructure;
automatically generating a discovery report describing the at least one components and at least one additional component;
automatically collecting pricing information of the at least one components and at least one additional component;
automatically comparing the collected pricing information; and
automatically generating a pricing comparison report.

2. The method of claim 1, further comprising identifying and parsing data fields in the collected file and custom file.

3. The method of claim 1, further comprising automatically monitoring for changes in the at least one component and the at least one additional component in the infrastructure.

4. The method of claim 1, further comprising performing a health check and standards validation on the at least one component in the infrastructure.

5. The method of claim 1, further comprising automatically generating at least one of a local server discovery report, a local storage discovery report, a local switch discovery report, an end-to-end server discovery report, an end-to-end storage discovery report, and an end-to-end switch discovery report.

6. The method of claim 1, further comprising automatically generating an infrastructure end of life/end of support report.

7. The method of claim 1, further comprising enabling a user to create favorite views by receiving specification of category and filter for information to be presented.

8. The method of claim 1, further comprising enabling a user to create dynamic charts by receiving specification of category, chart type, and fields for information to be presented.

9. The method of claim 1, further comprising enabling a user to create at least one filter criteria for information to be presented.

10. The method of claim 1, further comprising enabling a user to share created views, charts, and filter criteria to other users and sites.

11. An automated infrastructure cost optimization system comprising:
a logic module configured to:
automatically execute a script configured to collect information about at least one component of an infrastructure and generating a log file describing the at least one component;
receive a custom file specifying application and static information at least one additional component in the infrastructure;
automatically generate a discovery report describing the at least one components and at least one additional component;
automatically collect pricing information of the at least one components and at least one additional component;
automatically compare the collected pricing information; and
automatically generating a pricing comparison report.

12. The system of claim 11, wherein the logic module is further configured to automatically monitor for changes in the at least one component and the at least one additional component in the infrastructure.

13. The system of claim 11, wherein the logic module is further configured to perform a health check and standards validation on the at least one component in the infrastructure.

14. The system of claim 11, wherein the logic module is further configured to automatically generate at least one of a local server discovery report, a local storage discovery report, a local switch discovery report, an end-to-end server discovery report, an end-to-end storage discovery report, and an end-to-end switch discovery report.

15. The system of claim 11, wherein the logic module is further configured to automatically collect end of life/end of support information of the at least one components and at least one additional component, and automatically generate an end of life/end of support report of the at least one components and at least one additional component.

16. An automated infrastructure cost optimization method comprising:
executing a script configured to collect information about at least one component of an infrastructure and generating a log file describing the at least one component;
receiving a custom file specifying application and static information at least one additional component in the infrastructure;
automatically collecting pricing information of the at least one components and at least one additional component from a plurality of cloud vendors;
automatically comparing the collected pricing information from the plurality of cloud vendors; and
automatically generating a pricing comparison report.

17. The method of claim 16, further comprising:
automatically generating a discovery report describing the at least one components and at least one additional component; and
automatically monitoring for changes in the at least one component and the at least one additional component in the infrastructure.

18. The method of claim 16, further comprising performing a health check and standards validation on the at least one component in the infrastructure.

19. The method of claim 16, further comprising automatically generating at least one of a local server discovery report, a local storage discovery report, a local switch discovery report, an end-to-end server discovery report, an end-to-end storage discovery report, an end-to-end switch discovery report, and an infrastructure end of life/end of support report.

20. The method of claim 16, further comprising enabling a user to create at least one of favorite views by receiving specification of category and filter for information to be presented, dynamic charts by receiving specification of category, chart type, and fields for information to be presented, at least one filter criteria for information to be presented, and further enabling the user to share created views, charts, and filter criteria to other users and sites.
